(19) United States
(12) Patent Application Publication
(10) Pub. No.: US 2010/0333033 A1
(43) Pub. Date: Dec. 30, 2010

(54) PROCESSING GRAPHICAL USER INTERFACE (GUI) OBJECTS

(75) Inventors: Rick MF Wu, Taipei (TW); Jason CS Yang, Taipei (TW); Chen-Yu Kuo, Taipei (TW); Meng Li Wong, Taipei (TW)

Correspondence Address: HOLLAND & KNIGHT, 10 ST. JAMES AVENUE, BOSTON, MA, 02116-3889, US

(73) Assignee: International Business Machines Corporation, Armonk, NY (US)

(21) Appl. No.: 12/821,787

(22) Filed: Jun. 23, 2010

(30) Foreign Application Priority Data
Jun. 26, 2009 (TW) 98121589

(51) Int. Cl. G06F 3/048

(52) U.S. Cl. 715/835

(57) ABSTRACT

A computer apparatus and method for processing GUI objects is provided. The computer apparatus may include a recognition module and an object pick-up module. The recognition module may be configured to recognize a predetermined graphic mark on a GUI. The object pick-up module may be configured to pick up a GUI object having the predetermined graphic mark embedded therein.

### RELATED APPLICATIONS

This application claims priority of Taiwan Patent Application Serial No. 98121589 entitled “Computer Apparatus and Method for Processing Graphic User Interface (GUI) Objects”, filed on Jun. 26, 2009.

### BACKGROUND OF THE INVENTION

The present invention relates to software automation, and more particularly to automation for software testing. Software may have become an inevitable production tool, but when executing, typically it may passively need a user's command to determine or select subsequent processing steps. Particularly for the quality assurance (QA) in software testing, a QA engineer may have to execute, repeatedly, a series of commands with the software, to make sure the software can proceed with all processing steps correctly, as expected. For example, when the software has a graphical user interface (GUI), the QA engineer may have to click or make an input to each GUI object in the software, manually, which may be inefficient.

To address this, there may have been many conventional products which may be able to automatically send commands to software for a user. For example, Rational® Functional Tester of IBM Corporation may be provided for testing engineers and GUI developers to perform the automation and the regression testing for Java, .NET applications, or Web applications. In general, in conventional automation for software testing, a testing script may have been prepared in advance and could be, for example, written in Java or other programming languages. It then may have been played back in the testing environment. Accordingly, it may be important for the automation testing tool (or other automation processing tools) to correctly recognize the GUI objects in the software.

### BRIEF SUMMARY OF THE INVENTION

In one embodiment, a computer apparatus for processing GUI objects may comprise a recognition module and an object pick-up module. The recognition module may be configured to recognize a predetermined graphic mark on a GUI. The object pick-up module may be configured to pick up a GUI object having the predetermined graphic mark embedded therein.

In another embodiment, a method for processing GUI objects may comprise recognizing a predetermined graphic mark on a GUI. The method may further comprise picking up a GUI object having the predetermined graphic mark embedded therein.

In still another embodiment, a method for processing GUI objects may comprise providing a plurality of different graphic marks. The method may further comprise generating a GUI object. The method may additionally comprise selecting one graphic mark from the plurality of different graphic marks. The method may also comprise embedding the selected graphic mark into the GUI object.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

The drawings referred to below may depict only typical embodiments of the invention and are not considered to be limiting of its scope. The invention will be described and explained with additional specificity and detail through the use of the accompanying drawings.

FIG. 1A is an exemplary diagram of computer apparatus according to an embodiment of the present invention;

FIG. 1B is an exemplary block diagram of modules in the computer apparatus according to one embodiment of the present invention;

FIG. 2A is a flowchart for software development according to one embodiment of the present invention;

FIG. 2B shows GUI objects according to one embodiment of the present invention;

FIG. 2C shows GUI objects having embedded graphic mark according to one embodiment of the present invention; and

FIG. 3 is a flowchart for software automation testing according to one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a server, a client device, a method or a computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer or server may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the present invention may relate to the processing of GUI objects. For example, GUI objects (sometimes referred to as window objects or GUI widgets) may be buttons, checked boxes, list boxes, menus, text boxes, labels, etc. Notably, in different versions of software, a given GUI object may be in different positions or have different sizes. For example, a button labeled as “STOP” may have different sizes in English version and in Chinese version, and may be accordingly placed in slightly different positions. Or when some GUI objects are added or deleted in an updated version of the software, the remaining GUI objects may be affected in size of in position arrangement. Further, even for the same version of the software, a given GUI object may be in different positions or have different sizes when being shown in different displays (which may have resolution of 1024*768 pixels and 800*600 pixels, for example).

A GUI object may be recognized according to a predetermined graphic mark embedded in the GUI object. Particularly, the GUI object may be recognized based on the shape, color, or other characteristics of the predetermined graphic mark embedded in the GUI object. Alternatively, an automation processing or an automation testing may be provided to the recognized GUI object. Further, an apparatus may be provided to recognize a GUI object and to allow the GUI object to have different positions or sizes in a display. Therefore in a variety of execution environments (for example, different language settings or software versions or any design changes, etc.), the change of user interface layout may not affect the recognition result. Additionally a predetermined graphic mark may be embedded into a GUI object to be recognized. The GUI object could be recognized using the predetermined graphic mark. Alternatively, after the “debug mode” compiling, the predetermined graphic mark may be removed in “release mode”.

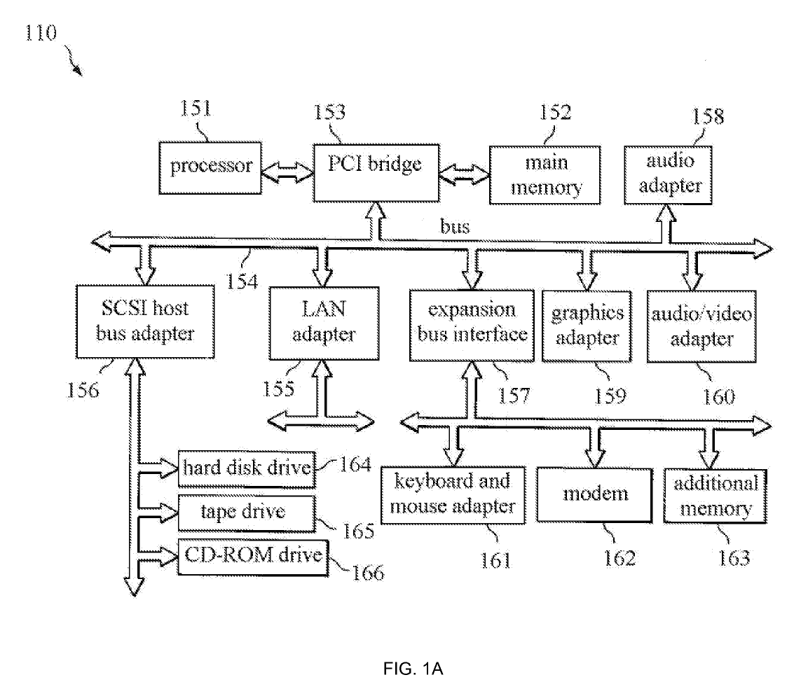

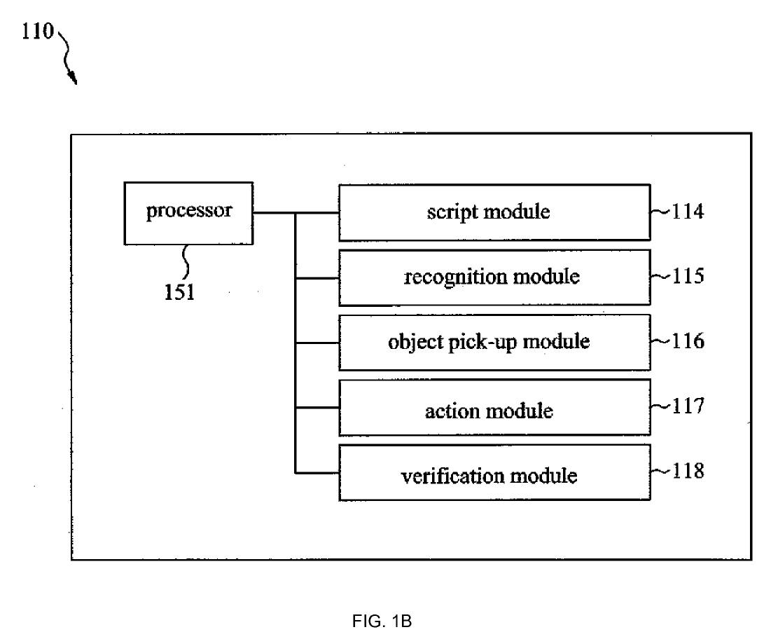

Referring now to FIG. 1A through FIG. 3, a system, devices, methods, and computer program products are illustrated as structural or functional block diagrams or process flowcharts according to various embodiments of the present invention. The flowchart and block diagrams in the Figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 1A is an exemplary block diagram of a computer apparatus 110 according to one embodiment of the present invention. The computer apparatus 110 may employ a peripheral component interconnect (PCI) local bus architecture. Although the depicted example employs a PCI bus, other bus architectures such as Accelerated Graphics Port (AGP) and Industry Standard Architecture (ISA) may be used. Processor 151 (e.g., a CPU of Intel Corporation or Advanced Micro Devices, Inc.) and main memory 152 may be connected to PCI local bus 154 through PCI bridge 153. PCI bridge 153 also may include an integrated memory controller and cache memory for processor 151.

In the depicted example, local area network (LAN) adapter 155, small computer system interface (SCSI) host bust adapter 156, and expansion bus interface 157 may be connected to PCI local bus 154 by direct component connection. In contrast, audio adapter 158, graphics adapter 159, and audio/video adapter 160 may be connected to PCI local bus 154 by add-in boards inserted into expansion slots. Expansion bus interface 157 may provide a connection for a keyboard and mouse adapter 161, modem 162, and additional memory 163. SCSI host bus adapter 156 may provide a connection for hard disk drive 164, tape drive 165, and CD-ROM drive 166. Typical PCI local bus 154 implementations may support three or four PCI expansion slots or add-in connectors.

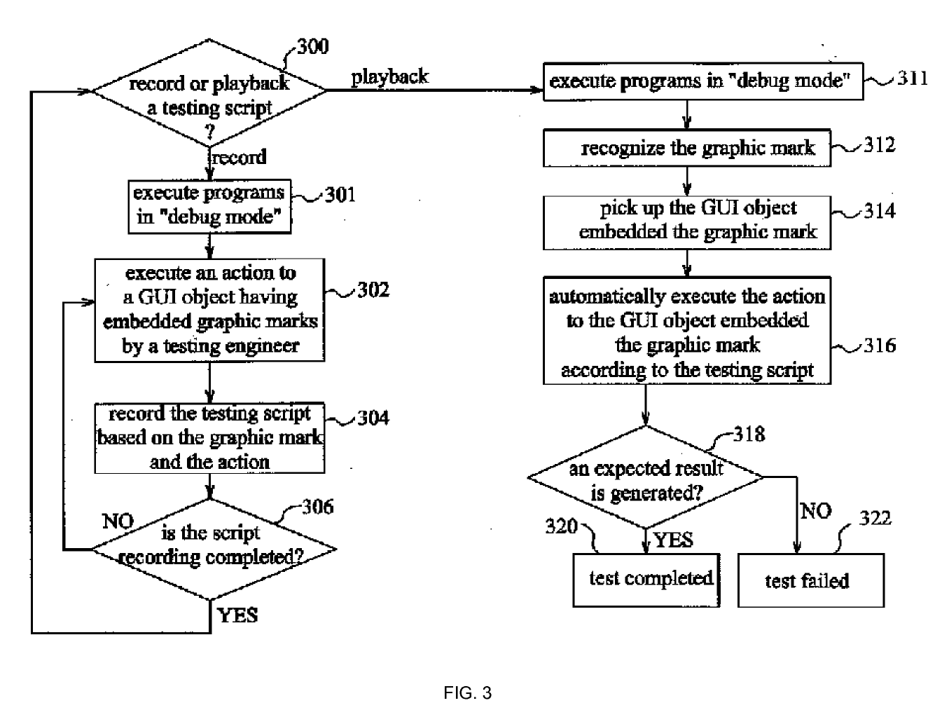

An operating system may run on the processor 151 and may be used to coordinate and provide control of various components within the computer apparatus 110, and may also be used to execute applications/programs with GUIs. The operating system may be a commercially available operating system such as Windows XP® of Microsoft Corporation, which may be a GUI characterized operation system. Examples of applications/programs with GUI may be Internet Explorer® browser of Microsoft Corporation or Flash® Player of Adobe Systems Inc. The GUIs may be referred to as “windows”. Instructions for the operating system, and applications or programs may be located on storage devices, such as the hard disk drive 154, and may be loaded into the main memory 152 for execution by the processor 151. As shown in FIG. 1B, the processor 151 may also execute applications/programs to provide the script module 114, the recognition module 115, the object pick-up module 116, the action module 117, and the verification module 118, which will be explained later in connection with FIG. 3.

In the following, an embodiment of software automation testing may be provided to explain the present invention. However, the processing or the recognition of GUI objects is not limited to the software automation testing. The present invention may be useful whenever there is a need to automatically recognize or process GUI objects.

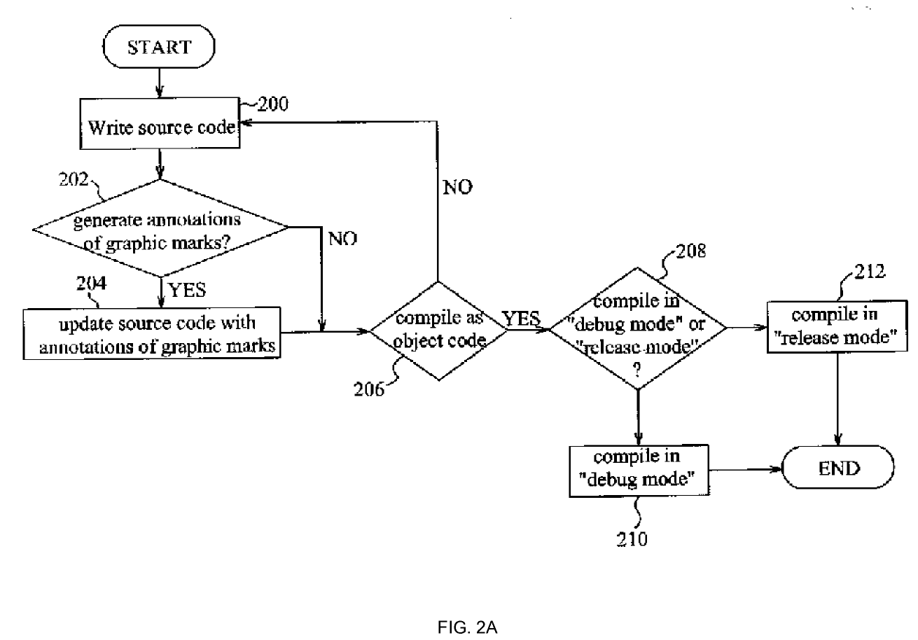

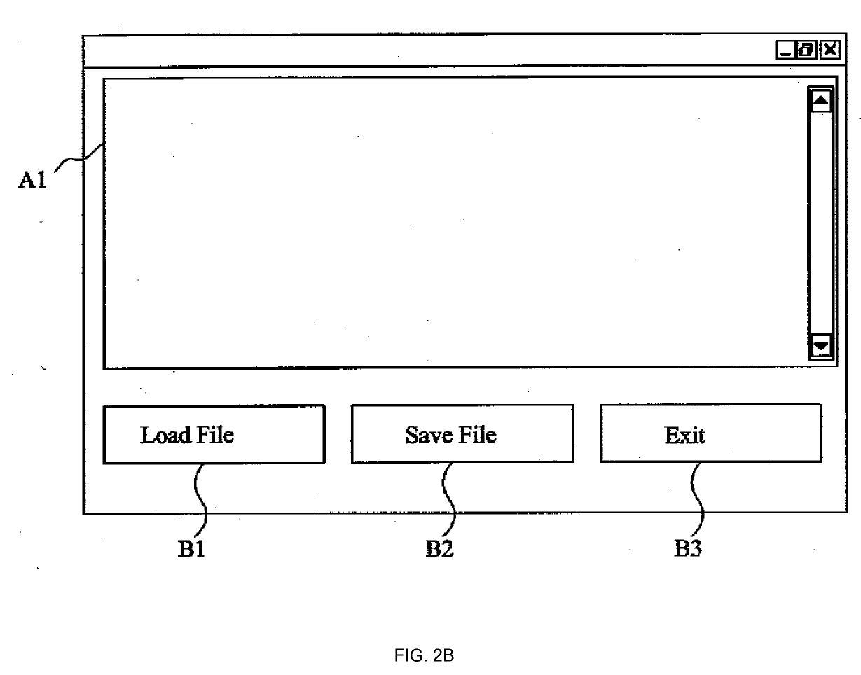

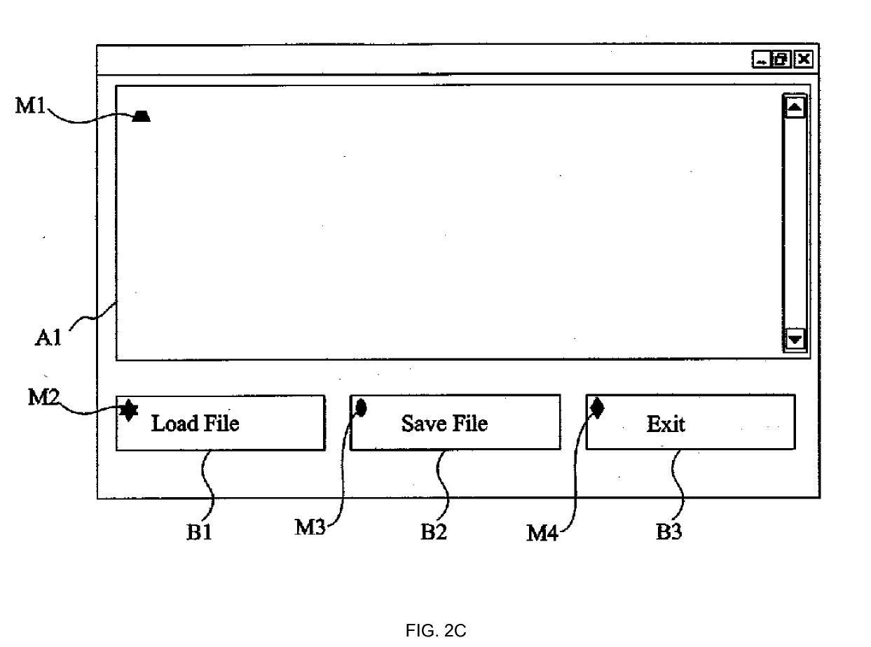

FIG. 2A shows a flowchart of software development in Java®, according to an embodiment of the present invention. Those skilled in the art will understand that the illustrated flowchart in FIG. 2A may also apply to software development in other programming languages.

At operation 200, source codes may be written, particularly for a GUI and GUI objects. In the following example shown in FIG. 2B, there may be 4 GUI objects—a text box A1 (which may correspond to “textarea” in the source codes) and buttons B1-B3, labeled as “Load File”, “Save File”, and “Exit” (which may correspond to “button”, “button1” and “button2” in the source codes). The corresponding source codes may be shown as follows, but some source codes which may be less relevant to the present invention may be omitted.

:

TextArea=new Test(sShell, SWT.MULTI| SWT.WRAP|
SWT.V_SCROLL|
SWT.BORDER|);
Button=new Button(sShell, SWT.NONE);
Button1=new Button(sShell, SWT.NONE);
Button2=new Button(sShell, SWT.NONE);
sShell.setText(title);
Button,setText(“Load File”);
Button1,setText(“Save File”);
Button2,setText(“Exit”);
sShell.setSize(new Pint(246, 172));

:

At operation 202, it may be determined whether to generate annotations of graphic marks. If “not”, proceed to the operation 206, which will be discussed later.

If the determination at operation 202 is “yes”, annotations of graphic marks may be added (or updated) in the source codes of the GUI objects at operation 204, in order to embed the graphic marks into the GUI objects. For the 4 GUI objects A1, B1-B3 shown in FIG. 2B, 4 different graphic marks may be selected from a predetermined group of graphic marks maintained in the software development environment. In this example, 4 graphic marks, i.e., a trapezoid M1, a star M2, an ellipse M3, and a diamond M4 (which may correspond to the annotations “mark1”, “mark2”, “mark3”, and “mark4” in source codes) may be embedded into the text box A1 and buttons B1-B3. These 4 graphic marks may be distinguished in shape, color, or other characteristics, which may be further defined by annotations “Preference1”, “Preference 2”, “Preference 3”, and “Preference 4” in source codes. For example, these 4 graphic marks may be “red”, “green”, “blue”, and “black”, respectively, but this may not be necessary in the present invention.

Note that the graphic marks may have irregular shapes or special colors to enhance the correctness of recognition. In addition, when compiling in “release mode” at operation 212, the compiler may omit these annotations of graphic marks, so that those embedded graphic marks may not appear on the GUI objects in the final version of software, which may have completed the test and may be ready to release. In other words, these graphic marks may become “hidden”. In the following, corresponding annotations of graphic marks may be highlighted in boldface. Compared to FIG. 2B, FIG. 2C shows 4 GUI objects (i.e., the text box A1 and buttons B1-B3) which may have embedded graphic marks. The graphic mark may be placed on top of the GUI object and may be smaller than the GUI object so that may not interfere with the appearance or indication of the GUI object. From this aspect, the graphic mark may be referred to as a “watermark”.

:

TextArea=new Test(sShell, SWT.MULTI| SWT.WRAP|

SWT.V_SCROLL| SWT.BORDER|);

Button=new Button(sShell, SWT.NONE);
Button1=new Button(sShell, SWT.NONE);
Button2=new Button(sShell, SWT.NONE);
sShell.setText(title);
//insert mark1 for text area
@textArea.setwatermark(“mark1”, Preference1);
Button,setText(“Load File”);
//insert mark2 for “Load File” button
@button1.setwatermark(“mark2”, Preference2);
Button1,setText(“Save File”);
//insert mark3 for “Save File” button
@ button2.setwatermark(“mark3”, Preference3);
Button2,setText(“Exit”);
//insert mark4 for “Exit” button
@ button3.setwatermark(“mark4”, Preference4);
sShell.setSize(new Pint(246, 172));

:

At operation 206, it may be determined whether to compile source codes into object codes. If “not”, go back to operation 200. If “yes”, proceed to operation 208, where the software developer may determine whether to compile the source codes in “debug mode” (operation 210) or in “release mode” (operation 212) in the development environment.

Note that “debug mode” (operation 210) and “release mode” (operation 212) may only differ in that “debug mode” (operation 210) may be provided for the situation when the software development has not been finalized and the source codes still need revision and further testing, while “release mode” (operation 212) may be applied when the software development has been finalized and completed in testing. In one embodiment, graphic marks embedded in GUI objects may appear after the software may be compiled in “debug mode” and may be used for automation testing (explained later with FIG. 3). When compiling in “release mode” for the finalized software which has passed the testing, annotations of graphic marks in source codes may be omitted, and the graphic marks may be embedded for the purpose of automation may be hidden.

FIG. 3 shows an embodiment for automation testing performed with the modules in FIG. 1B. As noted above, the operations shown in the flowchart of FIG. 3 may be performed together with compiling in “debug mode” (operation 210) in FIG. 2A. However, those skilled in the art will understand the automation testing illustrated in FIG. 3 may apply to compiling in any other mode or even apply to any software automation processing other than automation testing.

First at operation 300, the testing engineer may determine whether to record a testing script or to playback the testing script. If a testing script is going to be recorded, programs may execute in “debug mode” (operation 301). Then at operation 302, according to logics of the software under test, the testing engineer may execute actions to GUI objects having embedded graphic marks (as shown in FIG. 2B). For example, the testing engineer may input some text (e.g., “abc”) in the text box A1 which may have an embedded graphic mark (a trapezoid) M1 and then may click the button B3 which may be labeled as “EXIT” and may have another embedded graphic mark (a diamond) M4.

At operation 304, the script module 114 (shown in FIG. 1B) may make an automation testing script according to the graphic marks embedded in GUI objects and the actions that the testing engineer executes to the GUI objects. In this example, the automation testing script may have entries as “1. trapezoid; input text: abc” and “2. diamond; exit”. The automation testing script may be an executable file, or it simply may include entries to be read by other applications to execute.

At operation 306, it may be determined whether the automation testing script is completed. If “not”, go back to operation 302. If “yes”, turn back to operation 300.

At operation 300, the testing engineer may decide to playback the testing script and may move to operation 311: execute programs in “debug mode”. In one embodiment, when the testing engineer decides to make the testing script at operation 300, he may proceed to operation 301 and execute programs in “debug mode” which may be for the software in a first version. However, when the testing engineer decides to playback the testing script at operation 300, he may proceed to operation 311 and may execute programs in “debug mode” which may be for the software in a second version. The difference between the first version and the second version, for example, may be that the later versions may include adding, removing, or relocating of GUI objects, adoptions for different operating systems (e.g., for Windows XP® and Linux), modifications for different language environments (e.g., for Chinese and English), arrangements on different display devices (e.g., for a desktop and a mobile device), presentations on display devices having different resolutions (e.g., for 1024*768 pixels and 640*480 pixels). Therefore, for different versions of software, given GUI objects may have different sizes or position arrangements.

At operation 312, from the GUI (e.g., the window shown in FIG. 2C) provided by the software under test, the recognition module 115 (shown in FIG. 1B) may recognize the graphic marks (the trapezoid M1 or the diamond M4) recorded in the testing script at operation 304. Alternatively, the recognition module 115 may first find out and separate all GUI objects (e.g., a text box and 3 buttons) existing on the GUI using conventional methods, and then may further recognize the GUI objects having embedded graphic marks, i.e., the trapezoid M1 or the diamond M4. Notably, in one embodiment, the GUI may be outputted and presented in a display (not shown) as a single graphic form under Windows operating system, by using VNC® Viewer of RealVNC Ltd, for example. In this kind of embodiment, because the whole GUI may be outputted as a single graphic form, it may be difficult to find out or separate the GUI objects on the GUI in advance.

In addition, at operation 312, the recognition module 115 may rely on a special shape of graphic mark to recognize a graphic mark. Those skilled in the art may refer to conventional Optical Character Recognition (OCR) or Hand-Writing Recognition for more details for implementation. In another embodiment, the recognition module 115 may also use the color of graphic mark to recognize a graphic mark.

At operation 314, the object pick-up module 116 may use the trapezoid M1 or the diamond M4 recognized at operation 312, to pick up the GUI object having the embedded trapezoid M1 (i.e., the text box A1 shown in FIG. 2C) or the GUI object having the embedded diamond M4 (i.e., the button B3 labeled as “EXIT” as shown in FIG. 2C).

After the object pick-up module 116 picks up the GUI object(s) at operation 314, the action module 117 (shown in FIG. 1B) may follows the testing script (operation 304) and may execute the action to the GUI object(s) having embedded graphic marks, in order to invoke a computer process corresponding to the GUI object(s). For example, the action module 117 may automatically input some text (e.g., “abc”) in the text box A1 which may have an embedded graphic mark (a trapezoid) M1 or may click the button B3 which may be labeled as “EXIT” and may have another embedded graphic mark (a diamond) M4.

At operation 318, the verification module 118 (shown in FIG. 1B) may verify whether the computer process invoked by the action module 117 at operation 316 generates an expected result. If “yes”, the test may be completed (operation 320). If “not”, the test may have failed (operation 322). More details for this part may be found in the verification process in conventional software debugging or testing.

Note that operations 312-316 mentioned above may apply to not only the software automation testing, but also other software automation processing, such as automation processing in a production line in a factory, or automation processing for web pages on the Internet. No matter what kind of automation application, operations 312-316 may have to be repeated many times. With the embodiments above, one testing script may apply to different versions of software, different operating systems, or different displays, without manual modifications, and meanwhile GUI objects may be correctly recognized to execute corresponding actions.

The description shown above is only about the preferred embodiments of the present invention and is not intended to limit the scope of the invention. Any equivalent variations or modifications made without departing from the spirit disclosed by the present invention are within the scope of the following claims.

What is claimed is:

1. A computer apparatus for processing GUI objects, said apparatus comprising:
a recognition module configured to recognize a predetermined graphic mark on a GUI; and
an object pick-up module configured to pick up a GUI object having said predetermined graphic mark embedded therein.

2. The computer apparatus according to claim 1, further comprising:
an action module configured to, after said object pick-up module picks up said GUI object, execute an action to said GUI object to invoke a computer process.

3. The computer apparatus according to claim 1, further comprising:
a script module configured to, before said recognition module recognizes said predetermined graphic mark, in response to a user executing an action to said GUI object, generate an automation script based on said predetermined graphic mark on said GUI object and said action of said GUI object; and
an action module configured to, after said object pick-up module picks up said GUI object, automatically execute said action to said GUI object according to said automation script.

4. The computer apparatus according to claim 3, further comprising:
a verification module configured to, after said action module executes said action to said GUI object according to said automation script and said action invokes a computer process, verify if said computer process generates an expected result.

5. The computer apparatus according to claim 3, wherein said GUI object is in a first version when said user executes said action to said GUI object, and said script module is configured to generate said automation script based on said GUI object in said first version and wherein said object pick-up module is configured to pick up said GUI object in a second version.

6. The computer apparatus according to claim 1, wherein said recognition module is configured to recognize said predetermined graphic mark based on the shape of said predetermined graphic mark.

7. The computer apparatus according to claim 1, wherein said recognition module is configured to recognize said predetermined graphic mark based on the color of said predetermined graphic mark.

8. The computer apparatus according to claim 1, wherein said GUI is outputted to a display as a single graphic form.

9. A method for processing GUI objects, said method comprising:
recognizing a predetermined graphic mark on a GUI; and
picking up a GUI object having said predetermined graphic mark embedded therein.

10. The method according to claim 9, further comprising:
after picking up said GUI object, executing an action with respect to said GUI object to invoke a computer process.

11. The method according to claim 9, further comprising:
before recognizing said predetermined graphic mark, in response to a user, executing an action to said GUI object;
generating an automation script based on said predetermined graphic mark on said GUI object and said action of said GUI object; and
after picking up said GUI object, executing said action to said GUI object according to said automation script.

12. The method according to claim 11, further comprising:
after executing said action to said GUI object according to said automation script to invoke a computer process, verifying if said computer process generates an expected result.

13. The method according to claim 11, wherein said GUI object is in a first version when said user executes said action to said GUI object, and the operation of generating said automation script further comprises:
generating said automation script based on said GUI object in said first version, wherein the operation of picking up said GUI object includes picking up said GUI object in a second version.

14. A method according to claim 11, wherein said GUI object is presented in a first display in response to said user executing said action to said GUI object, and the operation of generating an automation script further comprises:
generating said automation script based on said GUI object presented in said first display; and
wherein the method further comprises:
before recognizing said predetermined graphic mark, presenting said GUI object in a second display.

15. The method according to claim 9, wherein the operation of recognizing said predetermined graphic mark further comprises:
recognizing said predetermined graphic mark based on the shape of said predetermined graphic mark.

16. The method according to claim 9, wherein the operation of recognizing said predetermined graphic mark further comprises:
recognizing said predetermined graphic mark based on the color of said predetermined graphic mark.

17. The method according to claim 9, further comprising:
before the operation of recognizing said predetermined graphic mark, embedding said predetermined graphic mark into said GUI object.

18. The method according to claim 9, further comprising:
after the operation of picking up said GUI object, hiding said predetermined graphic mark on said GUI object.

19. The method according to claim 9, further comprising:
outputting said GUI in a display as a single graphic form.

20. A method for processing GUI objects, comprising:
providing a plurality of different graphic marks;
generating a GUI object;
selecting one graphic mark from the plurality of different graphic marks; and
embedding said selected graphic mark into said GUI object.
